(19) United States
(12) Patent Application Publication
(10) Pub. No.: US 2018/0155481 A1
(43) Pub. Date: Jun. 7, 2018

(54) ENERGY CURABLE HYPERBRANCHED POLYCARBONATE POLYOL BACKBONE POLYFUNCTIONAL ACRYLATES

(71) Applicant: BASF Corporation, Florham Park, NJ (US)

(72) Inventors: Paul Share, Ann Arbor, MI (US); Sebastian Berger, Ann Arbor, MI (US); Kenneth W. Satcher, Southhaven, MS (US)

(21) Appl. No.: 15/575,609

(22) PCT Filed: Mar. 24, 2016
(86) PCT No.: PCT/US2016/024000

§ 371 Date: Nov. 20, 2017

Related U.S. Application Data
(60) Provisional application No. 62/165,086, filed on May 21, 2015.
(60) Provisional application No. 62/236,471, filed on Oct. 2, 2015.

(51) Int. Cl. C08F 283/02; C08G 83/00; C09D 151/08; C09D 11/102; C09D 11/101; G02B 1/10

(52) U.S. Cl. CPC C08F 283/02; C08G 83/005; G02B 1/10; C09D 11/102; C09D 11/101; C09D 151/08

(57) ABSTRACT

A polymer includes a hyper-branched polyfunctional (meth)acrylate and having a polycarbonate backbone, wherein the polymer is a liquid at 25° C.

### CROSS-REFERENCE TO RELATED APPLICATIONS

This application claims benefit of U.S. Provisional Patent Application No. 62/165,086, filed on May 21, 2015, the entirety of which is incorporated herein by reference.

### FIELD

The present technology is generally related to energy-curable hyperbranched polyfunctional (meth)acrylates with a polycarbonate backbone, methods of their preparation through an azeotropic transesterification process, and their use in downstream applications.

### BACKGROUND

There are several factors which are critical to the commercial success of UV (ultraviolet light) and EB (electron beam) curable coatings and inks. As printing presses run at higher and higher speeds, reducing the hourly cost of production, there are increasing demands on the curing speed of inks and coatings. At the same time, there is considerable focus by converters on energy consumption, such that there is a trend towards lower mercury lamp energies, and in many cases, conversion to LED light sources. Both higher line speeds and lower intensity light sources place demands on the reactivity of the monomers and oligomers used in formulations for such applications.

Another important factor for packaging applications is the increasing use of film substrates in bags, pouches, and labels. These substrates are very thin in order to reduce cost, but as a result, any shrinkage that occurs in the coating and ink during the curing process can result in wrinkling or other distortion of the film. Furthermore, in some cases, there is adhesion loss of the ink or coating to the film. Since these films are often used to package foods or beverages, there are very strict limits on the migration of unreacted monomers from the ink or coating.

### SUMMARY

In one aspect a polymer is provided, which includes a hyperbranched polyfunctional (meth)acrylate with a polycarbonate backbone. The polymer may be a liquid at 25° C. The polymer may exhibit a viscosity of about 50 centipoise to about 10,000 centipoise at 25° C.

In another aspect, a process is provided for preparing a polymer that contains a hyperbranched polyfunctional (meth)acrylate with a polycarbonate backbone. The process includes contacting a hyperbranched polycarbonate and a (meth)acrylate in the presence of a catalyst in a solvent to form a reaction mixture; and heating the reaction mixture under azeotropic reflux conditions to form an alcohol or water. The reaction is pushed forward by the removal of the alcohol or water (produced as by-products) from the reaction mixture under azeotropic reflux conditions.

A further aspect provides another process of preparing the polymer described above. The process includes contacting a hyperbranched polycarbonate and a catalyst in a solvent to form a first reaction mixture; cooling the first reaction mixture to about 0° C.; adding an acryloyl halide to the first reaction mixture to form a second reaction mixture for which the temperature does not exceed about 5° C. during addition of the acryloyl halide; and after a predetermined amount of time, warming the second reaction mixture to about 25° C.

In yet another aspect, a polymer, containing a hyperbranched polyfunctional (meth)acrylate with a polycarbonate backbone, is provided, which is prepared by the processes disclosed herein.

### BRIEF DESCRIPTION OF THE DRAWINGS

FIG. 1A shows a comparison of cure energies of cyan, magenta, and yellow inks made from three different resins: Example 4, Comparative Example 4-1, and Comparative Example 4-2, according to Example 4.

FIG. 1B shows a comparison of percentage adhesions of cyan, magenta, and yellow inks made from three different resins: Example 4, Comparative Example 4-1, and Comparative Example 4-2, according to Example 4.

FIG. 1C shows a comparison of color densities of cyan, magenta, and yellow inks made from three different resins: Example 4, Comparative Example 4-1, and Comparative Example 4-2, according to Example 4.

FIG. 2 shows a comparison of the viscosity and cure energies of four resin systems: Resin System 1, Resin System 2, Resin System 3, and Resin System 4, each of which were made with four different low viscosity resins, including Example 4, dipentaerythritol hexaacrylate (DPHA), trimethylol triacrylate (TMPTA), and tripropylene glycol diacrylate (TPGDA) , according to Example 5.

### DETAILED DESCRIPTION

Various embodiments are described hereinafter. It should be noted that the specific embodiments are not intended as an exhaustive description or as a limitation to the broader aspects discussed herein. One aspect described in conjunction with a particular embodiment is not necessarily limited to that embodiment and can be practiced with any other embodiment(s).

As used herein, “about” will be understood by persons of ordinary skill in the art and will vary to some extent depending upon the context in which it is used. If there are uses of the term which are not clear to persons of ordinary skill in the art, given the context in which it is used, “about” will mean up to plus or minus 10% of the particular term.

The use of the terms “a” and “an” and “the” and similar referents in the context of describing the elements (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein may be performed in any suitable order unless otherwise indicated herein or otherwise clearly contradicted by context. The use of any and all examples, or exemplary language (e.g., “such as”) provided herein, is intended merely to better illuminate the embodiments and does not pose a limitation on the scope of the claims unless otherwise stated. No language in the specification should be construed as indicating any non-claimed element as essential.

In general, the term “substituted,” unless specifically defined differently, refers to an alkyl, alkenyl, alkynyl, aryl, or ether group, as defined below (e.g., an alkyl group) in which one or more bonds to a hydrogen atom contained therein are replaced by a bond to non-hydrogen or non-carbon atoms. Substituted groups also include groups in which one or more bonds to a carbon(s) or hydrogen(s) atom are replaced by one or more bonds, including double or triple bonds, to a heteroatom. Thus, a substituted group will be substituted with one or more substituents, unless otherwise specified. In some embodiments, a substituted group is substituted with 1, 2, 3, 4, 5, or 6 substituents. Examples of substituent groups include: halogens (i.e., F, Cl, Br, and I); hydroxyls; alkoxy, alkenoxy, alkynoxy, aryloxy, aralkyloxy, heterocyclyloxy, and heterocyclylalkoxy groups; carbonyls (oxo); carboxyls; esters; urethanes; oximes; hydroxylamines; alkoxyamines; aralkoxyamines; thiols; sulfides; sulfoxides; sulfones; sulfonyls; sulfonamides; amines; N-oxides; hydrazines; hydrazides; hydrazones; azides; amides; ureas; amidines; guanidines; enamines; imides; isocyanates; isothiocyanates; cyanates; thiocyanates; imines; nitro groups; nitriles (i.e., CN); and the like. For some groups, substituted may provide for attachment of an alkyl group to another defined group, such as a cycloalkyl group.

As used herein, “alkyl” groups include straight chain and branched alkyl groups having from 1 to about 20 carbon atoms, and typically from 1 to 12 carbons or, in some embodiments, from 1 to 8 carbon atoms. As employed herein, “alkyl groups” include cycloalkyl groups as defined below. Alkyl groups may be substituted or unsubstituted. Examples of straight chain alkyl groups include methyl, ethyl, n-propyl, n-butyl, n-pentyl, n-hexyl, n-heptyl, and n-octyl groups. Examples of branched alkyl groups include, but are not limited to, isopropyl, isobutyl, sec-butyl, t-butyl, neopentyl, and isopentyl groups. Representative substituted alkyl groups may be substituted one or more times with, for example, amino, thio, hydroxy, cyano, alkoxy, and/or halo groups such as F, Cl, Br, and I groups. As used herein the term haloalkyl is an alkyl group having one or more halo groups. In some embodiments, haloalkyl refers to a per-haloalkyl group. In general, alkyl groups may include in addition to those listed above, but are not limited to, 2-pentyl, 2-methylbutyl, 3-methylbutyl, 1,2-dimethylpropyl, 1,1-dimethylpropyl, 2,2-dimethylpropyl, 1-ethylpropyl, 2-hexyl, 2-methylpentyl, 3-methylpentyl, 4-methylpentyl, 1,2-dimethylbutyl, 1,3-dimethylbutyl, 2,3-dimethylbutyl, 1,1-dimethylbutyl, 2,2-dimethylbutyl, 3,3-dimethylbutyl, 1,1,2-trimethylpropyl, 1,2,2-trimethylpropyl, 1-ethylbutyl, 2-ethylbutyl, 1-ethyl-2-methylpropyl, 2-heptyl, 3-heptyl, 2-ethylpentyl, 1-propylbutyl, 2-ethylhexyl, 2-propylheptyl, 1,1,3,3-tetramethylbutyl, nonyl, decyl, n-undecyl, n-dodecyl, n-tridecyl, iso-tridecyl, n-tetradecyl, n-hexadecyl, n-octadecyl, n-eicosyl, and the like.

Cycloalkyl groups are cyclic alkyl groups such as, but not limited to, cyclopropyl, cyclobutyl, cyclopentyl, cyclohexyl, cycloheptyl, and cyclooctyl groups. In some embodiments, the cycloalkyl group has 3 to 8 ring members, whereas in other embodiments the number of ring carbon atoms range from 3 to 5, 6, or 7. Cycloalkyl groups may be substituted or unsubstituted. Cycloalkyl groups further include polycyclic cycloalkyl groups such as, but not limited to, norbornyl, adamantyl, bornyl, camphenyl, isocamphenyl, and carenyl groups, and fused rings such as, but not limited to, decalinyl, and the like. Cycloalkyl groups also include rings that are substituted with straight or branched chain alkyl groups as defined above. Representative substituted cycloalkyl groups may be mono-substituted or substituted more than once, such as, but not limited to: 2,2-; 2,3-; 2,4-; 2,5-; or 2,6-disubstituted cyclohexyl groups or mono-, di-, or tri-substituted norbornyl or cycloheptyl groups, which may be substituted with, for example, alkyl, alkoxy, amino, thio, hydroxy, cyano, and/or halo groups.

As used herein, “aryl”, or “aromatic,” groups are cyclic aromatic hydrocarbons that do not contain heteroatoms. Aryl groups include monocyclic, bicyclic and polycyclic ring systems. Thus, aryl groups include, but are not limited to, phenyl, azulenyl, heptalenyl, biphenylenyl, indacenyl, fluorenyl, phenanthrenyl, triphenylenyl, pyrenyl, naphthacenyl, chrysenyl, biphenyl, anthracenyl, indenyl, indanyl, pentalenyl, and naphthyl groups. In some embodiments, aryl groups contain 6-14 carbons, and in others from 6 to 12 or even 6-10 carbon atoms in the ring portions of the groups. The phrase “aryl groups” includes groups containing fused rings, such as fused aromatic-aliphatic ring systems (e.g., indanyl, tetrahydronaphthyl, and the like). Aryl groups may be substituted or unsubstituted.

As used herein, the term (meth)acrylic or (meth)acrylate refers to acrylic or methacrylic acid, esters of acrylic or methacrylic acid, and salts, amides, and other suitable derivatives of acrylic or methacrylic acid, and mixtures thereof. Illustrative examples of suitable (meth)acrylic monomers include, without limitation, the following methacrylate esters: methyl methacrylate, ethyl methacrylate, n-propyl methacrylate, n-butyl methacrylate (BMA), isopropyl methacrylate, isobutyl methacrylate, n-amyl methacrylate, n-hexyl methacrylate, isoamyl methacrylate, 2-hydroxyethyl methacrylate, 2-hydroxypropyl methacrylate, N,N-dimethylaminoethyl methacrylate, N,N-diethylaminoethyl methacrylate, t-butylaminoethyl methacrylate, 2-sulfoethyl methacrylate, trifluoroethyl methacrylate, glycidyl methacrylate (GMA), benzyl methacrylate, allyl methacrylate, 2-n-butoxyethyl methacrylate, 2-chloroethyl methacrylate, sec-butyl-methacrylate, tert-butyl methacrylate, 2-ethylbutyl methacrylate, cinnamyl methacrylate, crotyl methacrylate, cyclohexyl methacrylate, cyclopentyl methacrylate, 2-ethoxyethyl methacrylate, furfuryl methacrylate, hexafluoroisopropyl methacrylate, methallyl methacrylate, 3-methoxybutyl methacrylate, 2-methoxybutyl methacrylate, 2-nitro-2-methylpropyl methacrylate, n-octylmethacrylate, 2-ethylhexyl methacrylate, 2-phenoxyethyl methacrylate, 2-phenylethyl methacrylate, phenyl methacrylate, propargyl methacrylate, tetrahydrofurfuryl methacrylate and tetrahydropyranyl methacrylate. Example of suitable acrylate esters include, without limitation, methyl acrylate, ethyl acrylate, n-propyl acrylate, isopropyl acrylate, n-butyl acrylate (BA), n-decyl acrylate, isobutyl acrylate, n-amyl acrylate, n-hexyl acrylate, isoamyl acrylate, 2-hydroxyethyl acrylate, 2-hydroxypropyl acrylate, N,N-dimethylaminoethyl acrylate, N,N-diethylaminoethyl acrylate, t-butylaminoethyl acrylate, 2-sulfoethyl acrylate, trifluoroethyl acrylate, glycidyl acrylate, benzyl acrylate, allyl acrylate, 2-n-butoxyethyl acrylate, 2-chloroethyl acrylate, sec-butyl-acrylate, tert-butyl acrylate, 2-ethylbutyl acrylate, cinnamyl acrylate, crotyl acrylate, cyclohexyl acrylate, cyclopentyl acrylate, 2-ethoxyethyl acrylate, furfuryl acrylate, hexafluoroisopropyl acrylate, methallyl acrylate, 3-methoxybutyl acrylate, 2-methoxybutyl acrylate, 2-nitro-2-methylpropyl acrylate, n-octylacrylate, 2-ethylhexyl acrylate, 2-phenoxyethyl acrylate, 2-phenylethyl acrylate, phenyl acrylate, propargyl acrylate, tetrahydrofurfuryl acrylate and tetrahydropyranyl acrylate.

As used herein, the term “acrylic-containing group” or “methacrylate-containing group” refers to a compound that has a polymerizable acrylate or methacrylate group.

As used herein, the term “polyol” refers to an oligomer that includes 2 or more monomer units wherein each monomer unit has at least one alcohol functionality.

As used herein, the term “repeat unit” refers to a structurally repeating unit of a polymer. A repeat unit may be a monomeric unit or an oligomeric unit (i.e., includes two or more monomeric units).

As used herein, the term “branch repeat unit” refers to a repeat unit that has a valence of three or more and is covalently attached to, or capable of covalently attaching to, three or more repeat units. Thus, for example, a styrene repeat unit in a polystyrene polymer does not constitute a branch repeat unit.

As used herein, the term “backbone” refers to a longest chain of a polymer.

As used herein, the term “oligomer” refers to a structure that contains a relatively small number of monomeric units. As used herein, the term includes any structure having two or more monomeric units.

As used herein, the term “polymer” refers to a molecule that contains one or more monomer units.

As used herein, the term “hyperbranched” as it relates to a polymer refers to highly branched polymers that typically exhibit a globular structure. Hyperbranched polymers typically exhibit substantial irregularity in terms of branching pattern and structure, which typically results in substantial variation in molecular weight (often referred to as polydispersity).

One useful measure for assessing the amount of branching present in a polymer is the degree of branching. As used herein, the term “degree of branching” refers to the ratio of (a) the total number of branch repeat units included in a polymer to (b) the total number of repeat units included in the polymer. Hyperbranched polymers having any suitable degree of branching may be employed in compositions described herein. In certain embodiments, the hyperbranched polymers exhibit a degree of branching of at least about 4 to about 20 monomer units per molecule.

Care should generally be exercised in interpreting degree of branching information for hyperbranched polymers. For example, certain hyperbranched polymers may exhibit a degree of branching of less than about 0.2, yet include one or more hyperbranched polymer portions (or subunits) that exhibit a degree of branching of greater than about 0.2. This may be the case, for example, when a hyperbranched polymer core is chain extended using long chains of linear repeat units. If sufficiently chain extended, the overall degree of branching for such a polymer may be less than about 0.2.

The presence of branched repeat units located away from the backbone contributes to the tree-like branching pattern of hyperbranched polymers. Hyperbranched polymers of the disclosure may have any suitable number of branched repeat units located away from the backbone. The hyperbranched polymers may include at least 1 or a plurality (e.g., 2, 3, 4, 5, 6, 7, 8, 9, 10 or more, and so on) of branched repeat units located away from the backbone.

It has now been surprisingly found that hyperbranched polyfunctional (meth)acrylates with a polycarbonate backbone, as described herein in various embodiments, have a much lower viscosity than conventional technologies, and they are liquids at room temperature. The viscosities of the hyperbranched polyfunctional (meth)acrylates with a polycarbonate backbone are lower than the corresponding polyols, and are within the range of low molecular weight monomers. The hyperbranched polyfunctional (meth)acrylates with a polycarbonate backbone also have a much higher flexibility due to their branched structure while maintaining a high density of reactive, and available, acrylate groups. The hyperbranched polyfunctional (meth)acrylates with a polycarbonate backbone may be prepared with a high molecular weight (>1000 Daltons), to minimize the migration issues associated with lower molecular weight resins. As used herein, migration refers to the diffusion of the acrylate from a cured coating, ink, or other material that includes the acrylate. In other words, migration refers to the ability of the acrylate to be extracted from a coating, or other material, after curing, whether by non-polymerization, or degradation and subsequent extraction. Migration is not a desirable feature of coatings or other materials that incorporate acrylates, particularly for packaging applications.

The polymers containing hyperbranched polyfunctional (meth)acrylates with a polycarbonate backbone may be prepared at low temperature through an azeotropic transesterification process with an alkanol (meth)acrylate ester such as methyl (meth)acrylate, or through a direct esterification process with the use of an acryloyl halide or (meth)acrylic acid. Such polymers can be used in a variety of industrial applications including, but not limited to, ultra-violet or energy beam curable inks or coatings for printing, packing, adhesives, or industrial applications on paper, plastic, metal, glass, wood, or other substrates; compositions/formulations for optical fiber coatings; primers for the metallization of paper or plastic substrates; printing, packaging, adhesives, or industrial applications using suitable thermally activated catalysts in thermally cured applications; compositions/formulations for 3D printing applications; reactive monomers in water-based acrylic emulsions; and co-reactants with suitable amines to form an acrylated amine through a Michael addition. The polymers and compositions described herein resist shrinking. Accordingly, use where shrinkage of a coating may be problematic, the present polymers and composition may be employed.

In one aspect, a polymer is provided that includes a hyperbranched polyfunctional (meth)acrylate with a polycarbonate backbone, and which is a liquid at 25° C. In one embodiment, the polymer exhibits a viscosity from about 50 centipoise to about 10,000 centipoise at 25° C. In another embodiment, the polymer exhibits a viscosity from about 100 centipoise to about 1000 centipoise at 25° C.

In some embodiments, the hyperbranched polyfunctional (meth)acrylate with a polycarbonate backbone may contain from about 1 to about 100 acrylate groups, from about 2 to about 100 acrylate groups, from about 3 to about 100 acrylate groups, or from about 4 to about 100 acrylate groups per molecule. In one embodiment, the hyperbranched polyfunctional (meth)acrylate with a polycarbonate backbone may contain from about 4 to about 100 acrylate groups per molecule. In a certain embodiment, the hyperbranched polyfunctional (meth)acrylate with a polycarbonate backbone may contain 10 to 100 acrylate groups per molecule.

In one embodiment, the polymer may contain 1 to 50 monomer repeating units per molecule. In another embodiment, the polymer may contain 1 to 25 monomer repeating units per molecule. In yet another embodiment, the polymer may contain 1 to 16 monomer repeating units per molecule. In one embodiment, the polymer may contain 2 to 50 monomer repeating units per molecule. In another embodiment, the polymer may contain 2 to 25 monomer repeating units per molecule. In yet another embodiment, the polymer may contain 2 to 16 monomer repeating units per molecule.

In one embodiment, the polycarbonate backbone is a polycarbonate polyol, a polycarbonate polyester, a polycarbonate urethane, or is a co-polymer of any two or more thereof. In a further embodiment, the polycarbonate backbone is a polycarbonate polyol.

The polycarbonate polyol backbone may be prepared by reacting a polyfunctional alcohol with a polyfunctional ester or carbonate in the presence of a catalyst capable of catalyzing a transesterification reaction.

### Polycarbonate Polyol Backbone

A polycarbonate polyol backbone, also referred to herein as a hyperbranched polycarbonate polyol, can be prepared at low temperature (such as 70° C. to 140° C., low pressure steam heating) at higher transesterification yields than when prepared at high-temperature. This permits the use of the lower cost dimethyl carbonate, yielding the same hyperbranched polycarbonate polyol but at a lower raw material and production cost. As a result, the hyperbranched polycarbonate polyols can be manufactured in a wider range of manufacturing facilities than the high-temperature process allows.

It has been found that hyperbranched polycarbonate polyols with low viscosity and high reactivity may be prepared at low temperature. A process of preparing a hyperbranched polycarbonate polyol through azeotropic transesterification at low temperature is provided. The hyperbranched polycarbonate polyol prepared by the disclosed process has low viscosity and is a liquid at room temperature. The hyperbranched polycarbonate polyol can be used in a variety of industrial applications, including but not limited to, urethanes for foams, inks, plastics, or coatings applications; and humectants, dispersants or emulsifiers, or solvents.

In one aspect, a process is provided for preparing a hyperbranched polycarbonate polyol, the process including contacting in a solvent a polyfunctional alcohol and an ester or a carbonate with a catalyst to form a reaction mixture; and heating the reaction mixture under azeotropic reflux conditions to form an alcohol or water. During the reaction, the alcohol or water by-product is removed from the reaction mixture under the azeotropic reflux conditions, thereby pushing the reaction forward.

The polyfunctional alcohol of the disclosed process may be aliphatic or aromatic and may contain two or more alcohol functionalities. In one embodiment, the polyfunctional alcohol includes one or more primary alcohol functionalities. In another embodiment, the polyfunctional alcohol has two or more primary alcohol functionalities. The polyfunctional alcohol can be branched or unbranched, substituted or unsubstituted, and have 3 to 26 carbon atoms. The polyfunctional alcohol is (cyclo)aliphatic and aliphatic. In yet another embodiment, the polyfunctional alcohol is a triol.

In one embodiment, the polyfunctional alcohol has a hydroxyl value of about 100 to about 2000 mg KOH per gram.

In some embodiments, the polyfunctional alcohol is glycerol, trimethyolmethane, trimethylolethane, trimethylolpropane, trimethylolbutane, 1,2,4-butanetriol, tris(hydroxymethyl)amine, tris(hydroxyethyl)amine, tris(hydroxypropyl)amine, pentaerythritol, diglycerol, triglycerol, polyglycerols, bis(trimethylolpropane), tris(hydroxymethyl)isocyanurate, tris(hydroxyethyl)isocyanurate, phloroglucinol, trihydroxytoluene, trihydroxydimethylbenzene, phloroglucides, hexahydroxybenzene, 1,3,5-benzenetrimethanol, 1,1,1-tris(4′-hydroxyphenyl)methane, 1,1,1-tris(4′-hydroxyphenyl)ethane, a sugar, a sugar derivative, a polyetherol based on ethylene oxide, a polyetherol based on propylene oxide, a polyetherol based on butylene oxide, a polyesterol, or a combination of any two or more thereof.

In a further embodiment, the polyfunctional alcohol is a sugar, which is glucose. In yet another embodiment, the polyfunctional alcohol is a sugar derivative. Some examples of sugar derivatives include but are not limited to, sorbitol, mannitol, diglycerol, threitol, erythritol, adonitol (ribitol), arabitol (lyxitol), xylitol, dulcitol (galactitol), maltitol, or isomalt.

Other suitable polyfunctional alcohols include, but are not limited to, alkoxyamines and homopolymers of alkoxyamines. Some examples include but are not limited to triethanolamine and homopolymers of triethanolamine.

In certain embodiments, the polyfunctional alcohol is glycerol, trimethylolethane, trimethylolpropane, 1,2,4-butanetriol, pentaerythritol, a polyetherol based on ethylene oxide, a polyetherol based on propylene oxide, or a combination of any two or more thereof. In a further embodiment, the polyfunctional alcohol is an ethoxylated ethanol amine. In yet another embodiment, the polyfunctional alcohol is glycerol ethoxylate.

The ester of the disclosed process has a general formula of R¹C(O)OR² and may be aliphatic or aromatic and may contain one or more ester functionalities. The ester can be straight-chained or branched or substituted or un-substituted and can have 1-8 carbon atoms. Examples include but are not limited to methyl, ethyl, isopropyl, n-propyl, or n-butyl. In one embodiment, the ester is a C₂-C₈ ester. In a specific embodiment, the ester is a methyl ester. In a further embodiment, the ester is an anhydride of any ester disclosed herein.

During the azeotropic distillation of the disclosed process, the —OR² of the ester leaves to form the alcohol that is produced as a by-product throughout the reaction.

In an alternative embodiment, the polyfunctional alcohol can be contacted with a carbonate. The carbonate can be a simple carbonate of the general formula R¹O(CO)OR² wherein R¹ and R² is a straight chain or branched alkyl, cycloalkyl, or aryl group. In some embodiments, le and R² is a straight chain or branched C₁-Cᵤ alkyl, C₁-C₁₂ cycloalkyl, or a C₁-C₁₂ aryl group. In some embodiments, le is methyl, ethyl, or propyl, and R² is a straight chain or branched C₁-C₁₂ alkyl, C₁-C₁₂ cycloalkyl, or a C₁-C₁₂ aryl group. During the azeotropic distillation of the disclosed process, either the —OR¹ or —OR² leave to form the alcohol that is produced as a by-product in the reaction. For example, is R¹ is methyl, ethyl, or propyl, then the alcohol formed is methanol, ethanol, or propanol. In some embodiments, the carbonate is ethylene carbonate, 1,2-propylene carbonate, 1,3-propylene carbonate, or a combination of any two or more thereof.

In further embodiments, the carbonate is a dialkyl dicarbonate, dialkyl tricarbonate, or a combination of any two or more thereof. In some embodiments, the carbonate is dimethyl carbonate, diethyl carbonate, di-n-propyl carbonate, di-n-butyl carbonate, diisobutyl carbonate, or a combination of any two or more thereof. In a certain embodiment, the polyfunctional ester is dimethyl carbonate. In another embodiment, the polyfunctional ester is diethyl carbonate.

The amount of ester or carbonate used is from about 0.1 to about 1 equivalent of the ester or carbonate per 1 equivalent of the polyfunctional alcohol.

The catalyst used for the process disclosed herein includes any catalyst that is capable of catalyzing a transesterification reaction which includes all catalysts listed in Otera, Chem. Rev. 1993, 93, 1449-1470. Some examples of catalysts include but are not limited to, alkali metal hydroxides, alkali metal carbonates, alkali metal hydrogen carbonates, preferably of sodium, of potassium or of cesium, tertiary amines, guanidines, ammonium compounds, phosphonium compounds, organoaluminum, organotin, organozinc, organotitanium, organozirconium or organobismuth compounds, and also catalysts of the kind known as double metal cyanide (DMC) catalysts, as described, for example, in DE 10138216 or in DE 10147712, both of which are hereby incorporated by reference in their entireties. In some embodiments, the catalyst is a strong acid, a strong base, a mild transesterification catalyst, a Lewis acid, or a Bronsted acid. In other embodiments, the catalyst is an alkali alkoxide, alkali hydroxide, or a titanium tetraalkoxide.

Specific examples of catalysts include but are not limited to potassium hydroxide, potassium carbonate, potassium hydrogen carbonate, diazabicyclooctane (DABCO), diazabicyclononene (DBN), diazabicycloundecene (DBU), imidazoles, such as imidazole, 1-methylimidazole or 1,2-dimethylimidazole, titanium tetrabutoxide, titanium tetraisopropoxide, dibutyltin oxide, dibutyltin dilaurate, tin dioctoate, zirconium acetylacetonate, or mixtures of any two or more thereof. In some embodiments, the catalyst is potassium hydroxide, sodium hydroxide, or sodium methoxide. In some embodiments, the catalyst is sodium methoxide.

The amount of catalyst used in the disclosed process is from about 400 ppm to about 1000 ppm based on one part of the polyfunctional alcohol (based on weight of the monomers (polyfunctional alcohol and carbonate or ester) without solvent). In some embodiments, the amount of catalyst is about 1000 ppm based on one part of polyfunctional alcohol (based on weight of the monomers (polyfunctional alcohol and carbonate or ester) without solvent).

The contacting of the polyfunctional alcohol with the ester or carbonate with a catalyst in a solvent may occur in different orderings. For example, the contacting of the polyfunctional alcohol with the ester or carbonate with a catalyst can occur simultaneously. Alternatively, the contacting of the polyfunctional alcohol with the ester or carbonate with a catalyst can occur sequentially wherein the order of addition varies. In some embodiments, the polyfunctional alcohol is added to the solvent, followed by the addition of the ester or carbonate, and subsequently the addition of the catalyst.

The solvent of the disclosed process can be any solvent that can function as an azeotropic solvent. An azeotropic solvent is a solvent that that forms an azeotrope with another material such as an alcohol or water. Examples of an azeotropic solvent include but are not limited to C₅-C₁₀ alkane or C₅-C₁₀ cycloalkane. In some embodiments, the solvent is cyclohexane, toluene, dimethyl carbonate, or heptane. Other suitable examples include but are not limited to diethyl carbonate.

The polyfunctional alcohol, ester or carbonate, and catalyst are heated to achieve azeotropic reflux conditions to facilitate removal of an alcohol or water formed by the reaction. In one embodiment, the reaction mixture is heated to a temperature of about 70° C. to about 140° C. In an additional embodiment, the reaction mixture is heated from about 70° C. to about 110° C. In a further embodiment, the reaction mixture is heated to about 80° C. In some embodiments, the azeotropic mixture has a boiling point of about 54° C. The reaction is pushed forward by the removal of the alcohol or water by-product under the azeotropic reflux conditions.

The hyperbranched polycarbonate polyol formed by the process described herein have low viscosity and can be liquids at room temperature. The hyperbranched polycarbonate polyols prepared by the disclosed process have a viscosity of generally about 500 centipoise to greater than 100,000 centipoise at 25° C. For example, they can have a viscosity of about 900 centipoise to greater than 100,000 centipoise at 25° C. or about 1,000 centipoise to 30,000 centipoise at 25° C.

The hyperbranched polycarbonate polyols have less non-trans-esterified loose alkyl chain ends than hyperbranched polycarbonate polyols prepared at higher temperatures

The hyperbranched polycarbonate polyols have hydroxyl values of about 100 to about 500 mg KOH per gram. In one embodiment, the hyperbranched polycarbonate polyol has a hydroxyl value of from about 250 to about 350 mg KOH per gram.

The hyperbranched polycarbonate polyols may contain at least 2 to 50 monomer units per molecule. In some embodiments, the polyol may contain 2 to 25 monomer units per molecule. In other embodiments, the polyol may contain 2 to 15 monomer units per molecule.

### Polycarbonate Polyester/Urethane Backbone

The polycarbonate polyester backbone may be prepared from reacting hyperbranched polycarbonate polyols with an ester with a general formula of R¹C(O)OR², which can be aliphatic or aromatic and may contain one or more ester functionalities. The ester can be straight-chained or branched or substituted or un-substituted and can have 1-8 carbon atoms. Examples include but are not limited to methyl, ethyl, isopropyl, n-propyl, or n-butyl. In one embodiment, the ester is a C₂-C₈ ester. In a specific embodiment, the ester is a methyl ester. In a further embodiment, the ester is an anhydride of any ester disclosed herein.

The polycarbonate urethane backbone may be generally prepared from reacting hyperbranched polycarbonate polyols with isocyanates of various structures. The hyperbranched polycarbonate polyol can be reacted with any mono or polyfunctional isothiocyanate, which can be either aliphatic or aromatic. The reaction is generally conducted in a suitable solvent with an appropriate catalyst, the conditions of which are well known in the art. Some examples of isothiocyanates include, but are not limited to, methylene diphenyl diisocyanate, hexamethylene diisocyanate, and toluene diisocyanate.

### Hyperbranched Polyfunctional Meth(Acrylate)

In another aspect, a process is provided for preparing the hyperbranched polyfunctional (meth)acrylate with a polycarbonate backbone through an azeotropic transesterification process at low temperature. The process includes contacting a hyperbranched polycarbonate and an acrylate in the presence of a catalyst and a solvent, to form a reaction mixture, and heating the reaction mixture under azeotropic reflux conditions to form an alcohol or water from the reaction mixture. The reaction is pushed forward by the removal of the alcohol or water from the reaction mixture under the azeotropic reflux conditions.

The (meth)acrylate of the process disclosed above may be acrylic acid, methacrylic acid, methylmethacrylic acid, methylmethacrylate, ethylmethacrylate, and hydroxy vinyl ethers. Other suitable examples of the (meth)acrylic or (meth)acrylate include, but are not limited, to methyl acrylate, ethyl acrylate, n-propyl acrylate, isopropyl acrylate, n-butyl acrylate (BA), n-decyl acrylate, isobutyl acrylate, n-amyl acrylate, n-hexyl acrylate, isoamyl acrylate, 2-hydroxyethyl acrylate, 2-hydroxypropyl acrylate, N,N-dimethylaminoethyl acrylate, N,N-diethylaminoethyl acrylate, t-butylaminoethyl acrylate, 2-sulfoethyl acrylate, trifluoroethyl acrylate, glycidyl acrylate, benzyl acrylate, allyl acrylate, 2-n-butoxyethyl acrylate, 2-chloroethyl acrylate, sec-butyl-acrylate, tert-butyl acrylate, 2-ethylbutyl acrylate, cinnamyl acrylate, crotyl acrylate, cyclohexyl acrylate, cyclopentyl acrylate, 2-ethoxyethyl acrylate, furfuryl acrylate, hexafluoroisopropyl acrylate, methallyl acrylate, 3-methoxybutyl acrylate, 2-methoxybutyl acrylate, 2-nitro-2-methylpropyl acrylate, n-octylacrylate, 2-ethylhexyl acrylate, 2-phenoxyethyl acrylate, 2-phenylethyl acrylate, phenyl acrylate, propargyl acrylate, tetrahydrofurfuryl acrylate and tetrahydropyranyl acrylate, methyl methacrylate, ethyl methacrylate, n-propyl methacrylate, n-butyl methacrylate (BMA), isopropyl methacrylate, isobutyl methacrylate, n-amyl methacrylate, n-hexyl methacrylate, isoamyl methacrylate, 2-hydroxyethyl methacrylate, 2-hydroxypropyl methacrylate, N,N-dimethylaminoethyl methacrylate, N,N-diethylaminoethyl methacrylate, t-butylaminoethyl methacrylate, 2-sulfoethyl methacrylate, trifluoroethyl methacrylate, glycidyl methacrylate (GMA), benzyl methacrylate, allyl methacrylate, 2-n-butoxyethyl methacrylate, 2-chloroethyl methacrylate, sec-butyl-methacrylate, tert-butyl methacrylate, 2-ethylbutyl methacrylate, cinnamyl methacrylate, crotyl methacrylate, cyclohexyl methacrylate, cyclopentyl methacrylate, 2-ethoxyethyl methacrylate, furfuryl methacrylate, hexafluoroisopropyl methacrylate, methallyl methacrylate, 3-methoxybutyl methacrylate, 2-methoxybutyl methacrylate, 2-nitro-2-methylpropyl methacrylate, n-octylmethacrylate, 2-ethylhexyl methacrylate, 2-phenoxyethyl methacrylate, 2-phenylethyl methacrylate, phenyl methacrylate, propargyl methacrylate, tetrahydrofurfuryl methacrylate and tetrahydropyranyl methacrylate. Examples of other suitable acrylic and methacrylic moieties include, but are not limited to hydroxyalkyl acrylates and methacrylates, acrylic acid and its salts, acrylonitrile, acrylamide, methyl α-chloroacrylate, methyl 2-cyanoacrylate, N-ethylacrylamide, N,N-diethylacrylamide, acrolein, methacrylic acid and its salts, methacrylonitrile, methacrylamide, N-methylmethacrylamide, N-ethylmethacrylamide, N,N-diethylmethacrylamide, N,N-dimethylmethacrylamide, N-phenylmethacrylamide, methacrolein and acrylic or methacrylic acid derivatives containing cross-linkable functional groups, such as hydroxy, carboxyl, amino, isocyanate, glycidyl, epoxy, allyl, and the like.

The catalyst employed in the processes includes a catalyst that is capable of catalyzing transesterification reactions. Illustrative examples include the catalysts listed in Otera, Chem. Rev. 1993, 93, 1449-1470. Some examples of catalysts include but are not limited to, alkali metal hydroxides, alkali metal carbonates, alkali metal hydrogen carbonates, preferably of sodium, of potassium or of cesium, tertiary amines, guanidines, ammonium compounds, phosphonium compounds, organoaluminum, organotin, organozinc, organotitanium, organozirconium or organobismuth compounds, and also catalysts of the kind known as double metal cyanide (DMC) catalysts, as described, for example, in DE 10138216 or in DE 10147712. In some embodiments, the catalyst is a strong acid, a strong base, a transesterification catalyst, a Lewis acid, a Bronsted acid, or an amine. In other embodiments, the catalyst is an alkali alkoxide. In specific embodiments, the alkali alkoxide includes zinc isopropoxide, copper isopropoxide, zirconium acetoacetonate, or titanium tetra-isopropoxide.

Specific examples of catalysts include but are not limited to potassium hydroxide, potassium carbonate, potassium hydrogen carbonate, diazabicyclooctane (DABCO), diazabicyclononene (DBN), diazabicycloundecene (DBU), imidazoles, such as imidazole, 1-methylimidazole or 1,2-dimethylimidazole, titanium tetrabutoxide, titanium tetraisopropoxide, dibutyltin oxide, dibutyltin dilaurate, tin dioctoate, zirconium acetylacetonate, or mixtures thereof. In some embodiments, the catalyst is methane sulfonic acid, titanium isopropoxide, or an organotin reagent. In one embodiment, the organotin reagent is generated in situ through the reaction of sodium methoxide and dimethyltin dichloride. In some embodiments, the catalyst is sulfuric acid.

The amount of catalyst present in the disclosed process is from about 400 ppm to about 1000 ppm based on one part of the polycarbonate backbone (based on weight of the monomers (polycarbonate backbone and acrylate) without solvent). In some embodiments, the amount of catalyst is about 1000 ppm based on one part of polycarbonate backbone (based on weight of the monomers (polycarbonate backbone and acrylate) without solvent).

The contacting of the hyperbranched polycarbonate with the (meth)acrylate and catalyst in a solvent may occur in different orderings. For example, the contacting of the hyperbranched polycarbonate with the (meth)acrylate and the catalyst may occur simultaneously. Alternatively, contacting of the hyperbranched polycarbonate with the (meth)acrylate and catalyst may occur sequentially, wherein the order of addition varies. In some embodiments, the hyperbranched polycarbonate is added to the solvent, followed by the addition of the catalyst, and subsequently the addition of the (meth)acrylate.

The solvent of the disclosed process may be any solvent that can function as an azeotropic solvent. An azeotropic solvent is a solvent that forms an azeotrope with another material such as an alcohol or water. Examples of azeotropic solvents include but are not limited to C₅-C₁₀ alkanes, C₅-C₁₀ cycloalkane, and C₆-C₁₂ aromatic solvents. In some embodiments, the solvent is pentane, hexane, heptane, octane, nonane, decane, cyclohexane, methyl cyclohexane, or toluene.

Once the hyperbranched polycarbonate and acrylate are contacted with a catalyst in a solvent, the reaction mixture is heated to achieve azeotropic reflux conditions. In one embodiment, the reaction mixture is heated to about 70° C. to about 140° C. In another embodiment, the overhead temperature of the reaction has an azeotropic distillation temperature from about 40° C. to about 80° C. In some embodiment, the overhead temperature has an azeotropic distillation temperature of about 54° C. The reaction is pushed forward by the removal of the alcohol or water, produced as a by-product, under the azeotropic reflux conditions.

The hyperbranched polyfunctional (meth)acrylate with a polycarbonate backbone formed by the process described herein may contain a polycarbonate polyol that has a viscosity of about 500 centipoise to greater than 100,000 centipoise at 25° C. For example, the polycarbonate polyol can have a viscosity of about 900 centipoise to greater than 100,000 centipoise at 25° C. or about 1,000 centipoise to 30,000 centipoise at 25° C.

In another aspect, a process is provided for preparing polymers of a hyperbranched polyfunctional (meth)acrylate with a polycarbonate backbone. The process includes contacting a hyperbranched polycarbonate and a catalyst in a solvent to form a first reaction mixture; cooling the first reaction mixture to about 0° C.; adding an acryloyl halide to the first reaction mixture to form a second reaction mixture for which the temperature of the reaction does not exceed 5° C. during addition of the acryloyl halide; and after a predetermined amount of time, warming the second reaction mixture to about 25° C.

In one embodiment, the hyperbranched polycarbonate polyol contains secondary alcohol groups. In one embodiment, the catalyst is triethylamine. In another embodiment, the acryloyl halide is acryloyl chloride.

Also provided are polymers containing hyperbranched polyfunctional (meth)acrylates with a polycarbonate backbone prepared by the processes disclosed herein. These polymers exhibit low viscosity, can serve as highly functional resins, and are also energy curable. Such polymers are useful in a wide variety of industrial applications, including, but not limited, to ultra violet or electron beam curable inks or coatings for printing, packaging, adhesives, or industrial applications on paper, plastic, metal, glass or other substrates; compositions and formulations for optical fiber coatings; primers for the metallization of paper or plastic substrates; printing, packaging, adhesives, or industrial applications using suitable thermally activated catalysts in thermally cured applications; compositions and formulations for 3D printing applications; reactive monomers in water-based acrylic emulsions; co-reactants with suitable amines to form an acrylated amine through a Michael addition; and automotive applications. Automotive applications include both pigmented and non-pigmented formulations for interior plastic and metal components as well as exterior applications such as automotive paints and clearcoats in both OEM and refinish applications.

In another aspect, coating and ink compositions are provided, the constituents of which may include any of the above polymers. Illustrative polymers may include, but are not limited to those having hyperbranched polyfunctional (meth)acrylates with a polycarbonate backbone prepared by the processes disclosed herein. Such compositions may be used in ink formulations for a wide variety of uses including, but not limited to, optical fiber, electronic, adhesive, packaging, industrial printing, 3D printing, and automotive applications. Other uses of the coating composition may include fiber optic coatings.

In another aspect, provided herein are compositions comprising any of the above polymers. Illustrative polymers may include, but are not limited to those having hyperbranched polyfunctional (meth)acrylates with a polycarbonate backbone prepared by the processes disclosed herein. Such compositions may be used in formulations for a wide variety of uses including, but not limited to, conventional and inkjet printing, 3D printing, packaging applications, and automotive applications. Additional applications of such compositions include electronic applications such as printed circuit boards, photolithography, photomasks, as well as adhesives and laminates. Substrates may include paper, plastic, metal, glass, or wood.

In some embodiments, the compositions may contain one or more colorants. Colorants which can be used include the customary dyes and, in particular, customary pigments. Examples are inorganic pigments and also organic pigments. Some examples of inorganic pigments include, but are not limited to, titanium dioxide pigments, such as C.I. Pigment White 6, iron oxide pigments, interference pigments, such as metal effect pigments and pearl luster pigments, carbon blacks (e.g., C.I. Pigment Black 7), metal powders such as aluminum, brass or copper powder, and magnetic pigments, such as CrO₂, Fe₂O₃, Fe₃O₄, cobalt-modified iron oxides, barium ferrites, and pure iron pigments. Other non-limiting examples of inorganic pigments include white pigments, such as zinc white, color zinc oxide, lead white, zinc sulfide, and lithopone; black pigments, such as iron manganese black, spinel black, including Pigment Black 27, and iron oxide black, such as C.I. Pigment Black 11; color pigments, such as chromium oxide, chromium oxide hydrate green, chrome green, including C.I. Pigment Green 48, cobalt green, including C.I. Pigment Green 50, ultramarine green, cobalt blue, including C.I. Pigment Blue 28 and 36, ultramarine blue, iron blue, including C.I. Pigment Blue 27, manganese blue, ultramarine violet, cobalt and manganese violet, iron oxide red, including C.I. Pigment Red 101, cadmium sulfoselenide, including C.I. Pigment Red 108, molybdate red, including C.I. Pigment Red 104, ultramarine red, iron oxide brown, mixed brown, spinel and corundum phases, including C.I. Pigment Brown 24, 29 and 31, chrome orange, iron oxide yellow, including C.I. Pigment Yellow 42; nickel titanium yellow, including C.I. Pigment Yellow 53, C.I. Pigment Yellow 157 and 164, chromium titanium yellow, cadmium sulfide and cadmium zinc sulfide, including C.I. Pigment Yellow 37 and 35, chrome yellow, including C.I. Pigment Yellow 34, zinc yellow, alkaline earth metal chromates, Naples yellow, bismuth vanadate, including C.I. Pigment Yellow 184.

Some examples of organic pigments include but are not limited to monoazo pigments, such as C.I. Pigment Brown 25, C.I. Pigment Orange 5, 13, 36 and 67, C.I. Pigment Red 1, 2, 3, 5, 8, 9, 12, 17, 22, 23, 31, 48:1, 48:2, 48:3, 48:4, 49, 49:1, 52:1, 52:2, 53, 53:1, 53:3, 57:1, 251, 112, 146, 170, 184, 210 and 245, and C.I. Pigment Yellow 1, 3, 73, 74, 65, 97, 151 and 183; diazo pigments, such as C.I. Pigment Orange 16, 34 and 44, C.I. Pigment Red 144, 166, 214 and 242, and C.I. Pigment Yellow 12, 13, 14, 16, 17, 81, 83, 106, 113, 126, 127, 155, 174, 176 and 188; anthanthrone pigments, such as CI Pigment Red 168 and C.I. Vat Orange 3; anthraquinone pigments, such as C.I. Pigment Yellow 147 and 177 and C.I. Pigment Violet 31; anthrapyrimidine pigments, such as C.I. Pigment Yellow 108 and C.I. Vat Yellow 20; quinacridone pigments, such as C.I. Pigment Red 122, 202, and 201 and C.I. Pigment Violet 19; quinophthalone pigments, such as C.I. Pigment Yellow 138; dioxazine pigments, such as C.I. Pigment Violet 23 and 37; flavanthrone pigments, such as C.I. Pigment Yellow 24 and C.I. Vat Yellow 1; indanthrone pigments, such as C.I. Pigment Blue 60 and 64 and C.I. Vat Blue 4 and 6; isoindoline pigments, such as C.I. Pigment Orange 69, C.I. Pigment Red 260, and C.I. Pigment Yellow 139 and 185; isoindolinone pigments, such as C.I. Pigment Orange 61, C.I. Pigment Red 257 and 260, and C.I. Pigment Yellow 109, 110, 173 and 185; isoviolanthrone pigments, such as C.I. Pigment Violet 31 and C.I. Vat Violet 1; metal complex pigments, such as C.I. Pigment Yellow 117 and 153 and C.I. Pigment Green 8; perinone pigments, such as C.I. Pigment Orange 43, C.I. Vat Orange 7, C.I. Pigment Red 194, and C.I. Vat Red 15; perylene pigments, such as C.I. Pigment Black 31 and 32, C.I. Pigment Red 123, 149, 178, 179, 190 and 224, C.I. Pigment Violet 29, C.I. Vat Red 23, and C.I. Vat Red 29; phthalocyanine pigments, such as C.I. Pigment Blue 15, 15:1, 15:2, 15:3, 15:4, 15:6 and 16 and C.I. Pigment Green 7 and 36; pyranthone pigments, such as C.I. Pigment Orange 51, C.I. Pigment Red 216, and C.I. Vat Orange 4; thioindigo pigments, such as C.I. Pigment Red 88 and 181, C.I. Pigment Violet 38, C.I. Vat Violet 3, and C.I. Vat Red 1; triarylcarbonium pigments, such as C.I. Pigment Blue 1, 61 and 62, C.I. Pigment Green 1, C.I. Pigment Red 81, 81:1 and 169, and C.I. Pigment Violet 1, 2, 3 and 27. Other non-limiting examples of organic pigments include C.I. Pigment Black 1 (aniline black); C.I. Pigment Yellow 101 (aldazine yellow); C.I. Pigment Brown 22; C.I. Vat Yellow 2, 3, 4, 5, 9, 10, 12, 22, 26, 33, 37, 46, 48, 49 and 50; C.I. Vat Orange 1, 2, 5, 9, 11, 13, 15, 19, 26, 29, 30 and 31; C.I. Vat Red 2, 10, 12, 13, 14, 16, 19, 21, 31, 32, 37, 41, 51, 52 and 61; C.I. Vat Violet 2, 9, 13, 14, 15, 17 and 21; C.I. Vat Blue 1 (C.I. Pigment Blue 66), 3, 5, 10, 12, 13, 14, 16, 17, 18, 19, 20, 22, 25, 26, 29, 30, 31, 35, 41, 42, 43, 64, 65, 66, 72 and 74; C.I. Vat Green 1, 2, 3, 5, 7, 8, 9, 13, 14, 17, 26, 29, 30, 31, 32, 33, 40, 42, 43, 44 and 49; C.I. Vat Brown 1, 3, 4, 5, 6, 9, 11, 17, 25, 32, 33, 35, 38, 39, 41, 42, 44, 45, 49, 50, 55, 57, 68, 72, 73, 80, 81, 82, 83 and 84; and C.I. Vat Black 1, 2, 7, 8, 9, 13, 14, 16, 19, 20, 22, 25, 27, 28, 29, 30, 31, 32, 34, 36, 56, 57, 58, 63, 64 and 65.

Examples of preferred organic pigments are phthalocyanine blue 15:4, phthalocyanine green 7, green 36, yellow 12, yellow 14, red 57:1 and red 52:1. Mixtures of different dyes or colorants and also soluble organic dyes may be used in the compositions of the present application including inks and other coatings. The pigment loading may be any as are typically used in the art. In some embodiment, this may be from about 1 to about 50 wt % of colorant, relative to the sum of all the constituents of the composition. In some embodiments, the loading may be from about 5% to about 25% by weight of colorant, relative to the sum of all the constituents of the composition. In addition, dispersing agents made be used in conjunction with the resin and pigment composition to aid in pigment dispersion. These dispersants may include Solsperse® products such as Solsperse®39000, Byk products such as Disperbyk® 2013, and BASF products such as Efka® FX4701. These are representative examples of high molecular weight dispersants which have structures, such as block co-polymers, and functionalities, such as nitrogen-containing moieties, which assist in the dispersion and stabilization of pigment particles in the formulation, and are not intended to limit the scope of dispersants that may be utilized.

In some embodiments, the compositions are inks.

In some embodiments, the compositions are coating compositions. Such coating compositions may be used in ink formulation for a wide variety of uses including, but not limited to, printing, 3D printing, and packaging applications. Other uses of the coating composition may include fiber optic and automotive coatings.

### EXAMPLES

### Example 1

A polycarbonate polyol is dissolved in 5% process solvent (such as cyclohexane) in a reactor equipped with a mechanical stirrer, an addition funnel and a separation column with an overhead splitter possibility. An in-situ generated catalyst system is fed to the mixture in the following order and concentrations: 1) 0.8 mol % based on alcohol functionality of sodium methoxide solution in methanol; 2) 1.0 mol % based on alcohol functionality of dimethyltin dichloride in methanol. A sub-surface lean air purge is started and then 1.5 molar excess based on alcohol functionality of methyl(meth)acrylate and 2700 ppm monomethyl ether hydroquinone and 1900 ppm hydroquinone is charged to the reactor. The mixture is heated to reflux to a temperature at about 80° C. The transesterification reaction is started by the formation of an azeotropic mixture of methanol and cyclohexane, the boiling point of which is about 54.2° C. The reaction is driven towards the products by removal of the methanol through a azeotropic mixture continuously overhead, until the head temperature stops decreasing. After reaching a yield of 85 to 98% conversion (e.g., between 12 to 24 hours) based on esterified alcohol functionality (measured by hydroxyl value determination), the excess methyl acrylate and cyclohexane is distilled off. The product is re-dissolved in a solvent and washed/separated first with caustic water and then with deionized water. The final product is isolated by an intense vacuum strip to remove any residual water and solvent.

### Example 2

A hyperbranched polyol, 1.1 molar excess based on alcohol functionality of acrylic acids, 100 ppm phenothiazine, 300 ppm monomethyl ether hydroquinone, solvent (typically cyclohexane or methyl cyclohexane) and catalyst (strong acids, like sulfuric acid, methanesulfonic acid, p-toluenesulfonic acid) were added to a reactor equipped with a stirring unit, a water trap with reflux condenser, and an addition funnel. Methyl cyclohexane was then added as needed to achieve a reaction temperature of about 95-100° C. The reaction mixture was stirred for about 12 h at 110° C., or until the water trapping significantly slowed down. If conversion is above 95%, the distillation is started at reduced pressure and a maximum of 20° C. The solvent and the excess acrylic acid were distilled off in a vacuum to an acid value lower than 10 mgKOH/g. Alternatively, the acrylic acid containing polymer can be washed with caustic water in order to remove excess of monomer and inhibitor.

### Example 3

A hyperbranched polyol, 1.05 molar excess based on alcohol functionality of triethylamine, 100 ppm phenothiazine, 300 ppm monomethyl ether hydroquinone and solvent (typically 50 wt % dichloromethane based on monomer weight) were added to a reactor equipped with a stirring unit, a thermometer, a reflux condenser and an addition funnel. The reaction mixture was stirred at room temperature until it was homogeneous and subsequently cooled down to 0° C. using a bath with a saline ice water mixture. Acryloyl chloride was then fed to the cold mixture via an addition funnel, during which the reaction was not allowed to exceed 5° C. If the reaction exceeded 5° C., then the acryloyl chloride addition was either reduced or completely stopped. After all the acryloyl chloride had been added, the reaction was maintained below 5° C. for an additional 2 hours, after which the ice bath was removed and the reaction was allowed to warm up to room temperature overnight. The resulting cloudy, brownish mixture was processed to separate unwanted by-products from the main product using a two-fold deionized water wash procedure with a subsequent vacuum dry step. The product was re-dissolved in acetonitrile and filtered with a medium pore size filter frit and finally distilled to obtain the final clear, low viscous product at ca 95% hydroxyl conversion and 85% yield.

### Example 4

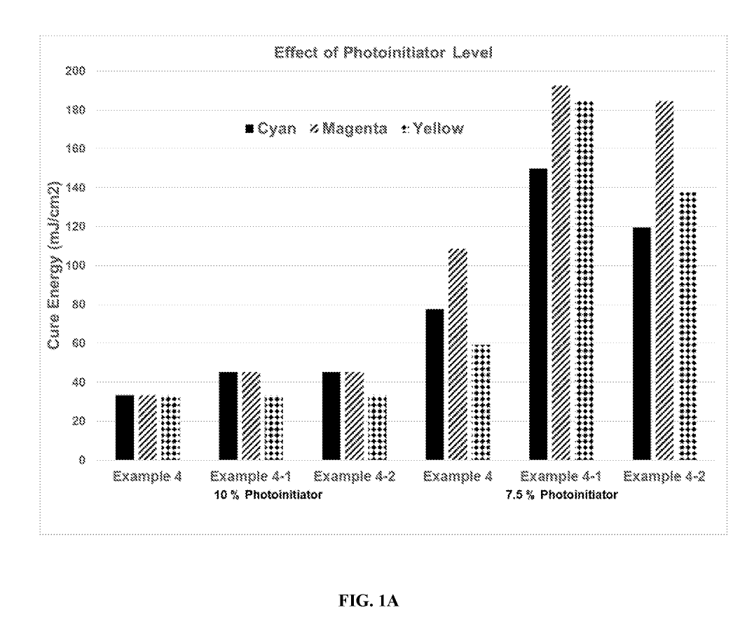

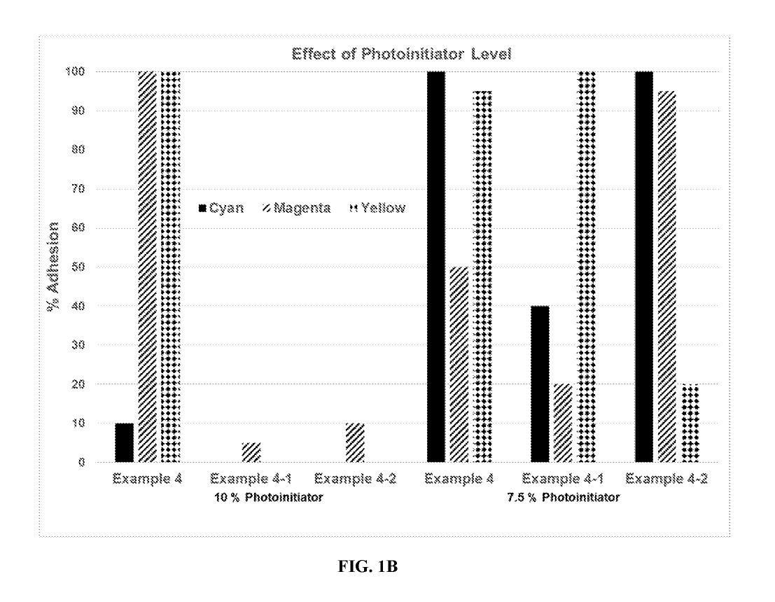

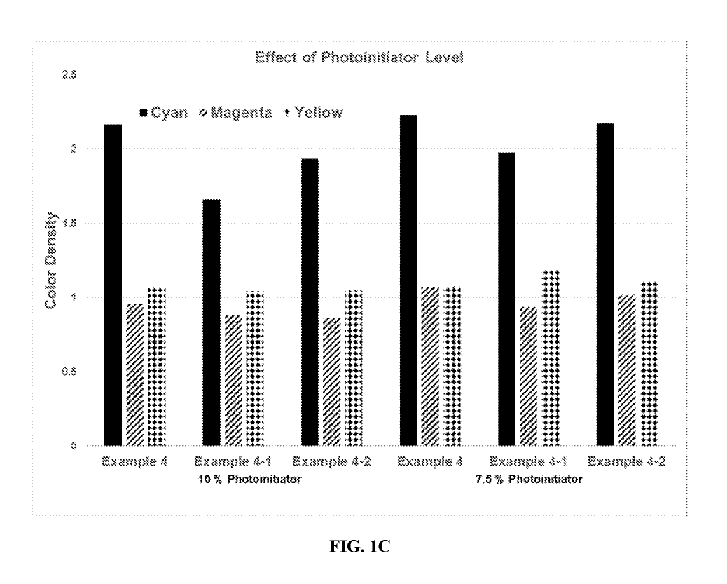

Cure energies, percent adhesion, and color density at different photo-initiator levels (7.5% and 10%) were compared between cyan, magenta, and yellow inks prepared from three resins: Example 4, Comparative Example 4-1, and Comparative Example 4-2. Example 4 is a resin containing a polymer that includes a hyperbranched polyfunctional (meth)acrylate and a polycarbonate backbone, as provided herein. Comparative Example 4-1 is a resin containing a UV curable pigment dispersing dimer acid resin. Comparative Example 4-2 is a resin containing a UV curable pigment dispersing polyester resin (see FIGS. 1A-1C). FIG. 1A shows that each of cyan, magenta, and yellow inks made from Example 4 exhibited much higher cure speeds, as demonstrated by the lower cure energies, than inks prepared from either Comparative Examples 4-1 or 4-2. FIG. 1A also illustrates that in order for inks prepared from Comparative Examples 4-1 or 4-2 to achieve comparable cure energies as inks prepared from Example 4, the amount of photo-initiator must be increased. Accordingly, the polymers provided herein allow for higher cure speeds at reduced photo-initiator levels, thereby reducing the ultimate cost of ink production.

FIG. 1B shows that at 10% photo-initiator level, only inks prepared from Example 4 exhibited high percentage adhesion, especially the magenta and yellow inks.

FIG. 1C shows that the cyan ink prepared from Example 4 exhibited higher color density than cyan inks prepared from either from Comparative Examples 4-1 or 4-2.

### Example 5

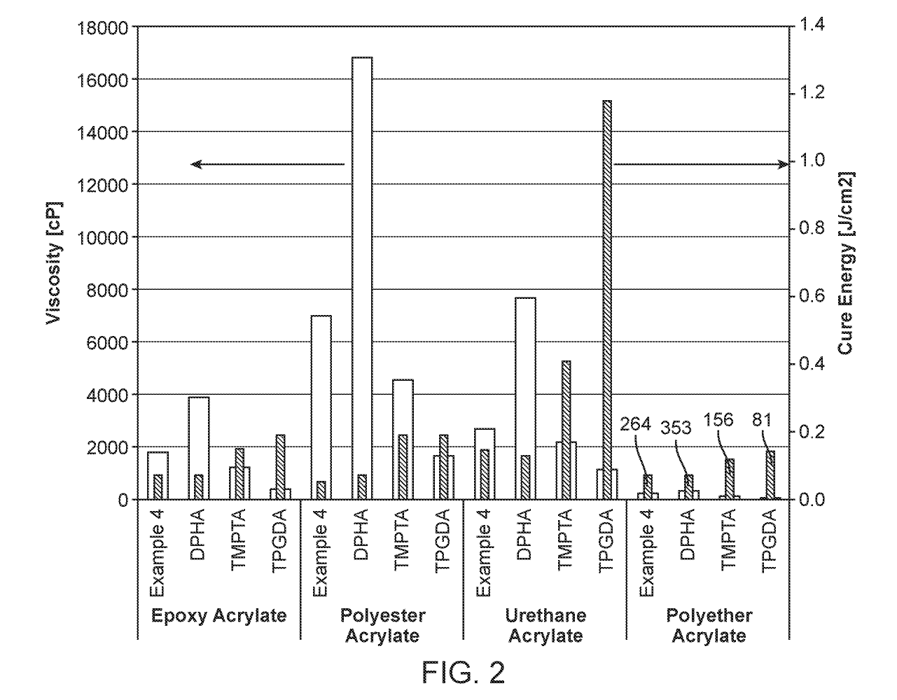

The viscosity and cure energies were compared between four resin systems: Resin System 1 (an epoxy acrylate), Resin System 2 (a polyester acrylate), Resin System 3 (a urethane acrylate), and Resin System 4 (a polyether acrylate), each of which were made with four different low viscosity resins, including Example 4 from above, dipentaerythritol hexaacrylate (DPHA), trimethylol triacrylate (TMPTA), and tripropylene glycol diacrylate (TPGDA). FIG. 2 shows that for each of the four resin systems, the resin system made with Example 4 exhibited the lowest viscosity and cure speeds.

The results from Examples 4 and 5 exemplify the advantages obtained with the polymers provided herein. Resins prepared from the polymers provided herein are highly functional with low viscosities and thus are able to achieve high percentage adhesion values and color densities while achieving high cure speeds.

### Illustrative Embodiments

The following is a description of non-limiting illustrative embodiments.

Para. A. A polymer comprising a hyperbranched polyfunctional (meth)acrylate and having polycarbonate backbone, wherein the polymer is a liquid at 25° C.

Para. B. The polymer of Para. A, wherein the polymer exhibits a viscosity from about 50 centipoise to about 10,000 centipoise at 25° C.

Para. C. The polymer of Para. A or B, wherein the polymer exhibits a viscosity from about 100 centipoise to about 1000 centipoise at 25° C.

Para. D. The polymer of any one of Paras. A-C, wherein the hyperbranched polyfunctional (meth)acrylate further comprising a polycarbonate backbone comprises from about 1 to about 100 acrylate groups per molecule.

Para. E. The polymer of any one of Paras. A-D, wherein the polymer comprises 2 to 50 monomer repeating units per molecule.

Para. F. The polymer of any one of Paras. A-E, wherein the polymer comprises 2 to 25 monomer repeating units.

Para. G. The polymer of any one of Paras. A-F, wherein the polymer comprises 2 to 15 monomer repeating units.

Para. H. The polymer of any one of Paras. A-G, wherein the polycarbonate backbone comprises a polycarbonate polyol, polycarbonate polyester, a polycarbonate polyurethane, or is a co-polymer of any two or more thereof.

Para. I. A process for preparing a polymer comprising a hyperbranched polyfunctional (meth)acrylate having a polycarbonate backbone, the process comprising: contacting in a solvent a hyperbranched polycarbonate and a (meth)acrylate in the presence of a catalyst to form a reaction mixture; and heating the reaction mixture under azeotropic reflux conditions to form an alcohol or water from the reaction mixture; wherein: the alcohol or water is removed from the reaction mixture under the azeotropic reflux conditions.

Para. J. The process of Para. I, wherein the heating is conducted from about 70° C. to about 140° C.

Para. K. The process of Para. I or J, wherein the catalyst comprises a strong acid, strong base, a transesterification catalyst, a Lewis acid, a Bronsted acid, or an amine.

Para. L. The process of any one of Paras. I-K, wherein the catalyst is an alkali alkoxide.

Para. M. The process of any one of Paras. I-L, wherein the catalyst is zinc isopropoxide, copper isopropoxide, zirconium acetoacetonate, or titanium tetra-isopropoxide.

Para. N. The process of any one of Paras. I-M, wherein the catalyst comprises sulfuric acid, methane sulfonic acid, titanium isopropoxide, or an organotin reagent.

Para. O. The process of any one of Paras. I-N, wherein the catalyst comprises the organotin reagent, and the organotin reagent is generated in situ through the reaction of sodium methoxide and dimethyltin dichloride.

Para. P. The process of any one of Paras. I-0, wherein an overhead temperature of the reaction has an azeotropic distillation temperature from about 40° C. to about 80° C.

Para. Q. The process of any one of Paras. I-P, wherein an overhead temperature of the reaction has an azeotropic distillation temperature of about 54° C.

Para. R. The process of any one of Paras. I-Q, wherein the solvent comprises a C₅-C₁₀ alkane, a C₅-C₁₀ cycloalkane, or an aromatic solvent.

Para. S. The process of any one of Paras. I-R, wherein the solvent comprises pentane, hexane, heptane, octane, nonane, decane, cyclohexane, methyl cyclohexane, benzene, or toluene.

Para. T. The process of any one of Paras. I-S, wherein the heating is from about 70° C. to about 140° C.

Para. U. The process of any one of Paras. I-T, wherein the heating is up to about 80° C.

Para. V. The process of any one of Paras. I-U, wherein the (meth)acrylate comprises acrylic acid, methacrylic acid, methylmethacrylic acid, methylmethacrylate, ethylmethacrylate, a hydroxy vinyl ether, methyl acrylate, ethyl acrylate, n-propyl acrylate, isopropyl acrylate, n-butyl acrylate (BA), n-decyl acrylate, isobutyl acrylate, n-amyl acrylate, n-hexyl acrylate, isoamyl acrylate, 2-hydroxyethyl acrylate, 2-hydroxypropyl acrylate, N,N-dimethylaminoethyl acrylate, N,N-diethylaminoethyl acrylate, t-butylaminoethyl acrylate, 2-sulfoethyl acrylate, trifluoroethyl acrylate, glycidyl acrylate, benzyl acrylate, allyl acrylate, 2-n-butoxyethyl acrylate, 2-chloroethyl acrylate, sec-butyl-acrylate, tert-butyl acrylate, 2-ethylbutyl acrylate, cinnamyl acrylate, crotyl acrylate, cyclohexyl acrylate, cyclopentyl acrylate, 2-ethoxyethyl acrylate, furfuryl acrylate, hexafluoroisopropyl acrylate, methallyl acrylate, 3-methoxybutyl acrylate, 2-methoxybutyl acrylate, 2-nitro-2-methylpropyl acrylate, n-octylacrylate, 2-ethylhexyl acrylate, 2-phenoxyethyl acrylate, 2-phenylethyl acrylate, phenyl acrylate, propargyl acrylate, tetrahydrofurfuryl acrylate and tetrahydropyranyl acrylate, methyl methacrylate, ethyl methacrylate, n-propyl methacrylate, n-butyl methacrylate (BMA), isopropyl methacrylate, isobutyl methacrylate, n-amyl methacrylate, n-hexyl methacrylate, isoamyl methacrylate, 2-hydroxyethyl methacrylate, 2-hydroxypropyl methacrylate, N,N-dimethylaminoethyl methacrylate, N,N-diethylaminoethyl methacrylate, t-butylaminoethyl methacrylate, 2-sulfoethyl methacrylate, trifluoroethyl methacrylate, glycidyl methacrylate (GMA), benzyl methacrylate, allyl methacrylate, 2-n-butoxyethyl methacrylate, 2-chloroethyl methacrylate, sec-butyl-methacrylate, tert-butyl methacrylate, 2-ethylbutyl methacrylate, cinnamyl methacrylate, crotyl methacrylate, cyclohexyl methacrylate, cyclopentyl methacrylate, 2-ethoxyethyl methacrylate, furfuryl methacrylate, hexafluoroisopropyl methacrylate, methallyl methacrylate, 3-methoxybutyl methacrylate, 2-methoxybutyl methacrylate, 2-nitro-2-methylpropyl methacrylate, n-octylmethacrylate, 2-ethylhexyl methacrylate, 2-phenoxyethyl methacrylate, 2-phenylethyl methacrylate, phenyl methacrylate, propargyl methacrylate, tetrahydrofurfuryl methacrylate, tetrahydropyranyl methacrylate, hydroxyalkyl acrylates and methacrylates, acrylic acid and its salts, acrylonitrile, acrylamide, methyl a-chloroacrylate, methyl 2-cyanoacrylate, N-ethylacrylamide, N,N-diethylacrylamide, acrolein, methacrylic acid and its salts, methacrylonitrile, methacrylamide, N-methylmethacrylamide, N-ethylmethacrylamide, N,N-diethylmethacrylamide, N,N-dimethylmethacrylamide, N-phenylmethacrylamide, or methacrolein.

Para. W. The process of any one of Paras. I-V, wherein the (meth)acrylate comprises an alkanol (meth)acrylate ester.

Para. X. The process of any one of Paras. I-W, wherein the (meth)acrylate comprises methyl (meth)acrylate.

Para. Y. The process of any one of Paras. I-X, wherein the polycarbonate polyol backbone comprises a polycarbonate polyol that has a viscosity of about 500 centipoise to greater than 100,000 centipoise at 25° C.

Para. Z. A polymer comprising a hyperbranched polyfunctional (meth)acrylate, further comprising a polycarbonate backbone, prepared by the process of any one of Paras. I-Y.

Para. AA. A process for preparing a polymer comprising a hyperbranched polyfunctional (meth)acrylate having a polycarbonate backbone, the process comprising: contacting a hyperbranched polycarbonate and a catalyst in a solvent to form a first reaction mixture; cooling the first reaction mixture to about 0° C.; adding an acryloyl halide or (meth)acrylic acid to the first reaction mixture to form a second reaction mixture, wherein a temperature of the reaction mixture does not exceed about 5° C. during addition; and after a predetermined amount of time, warming the second reaction mixture to about 25° C.

Para. AB. The process of Para. AA, wherein the hyperbranched polycarbonate polyol comprises secondary alcohol groups.

Para. AC. The process of Para. AA or AB, wherein the catalyst is triethylamine.

Para. AD. The process of any one of Paras. AA-AC, wherein the acryloyl halide is acryloyl chloride.

Para. AE. A polymer comprising a hyperbranched polyfunctional (meth)acrylate, further comprising a polycarbonate backbone, prepared by the process of any one of Paras. AA-AD.

Para. AF. A coating composition comprising the polymer of any one of Paras. A-H, Z, and AE.

Para. AG. The coating composition of Para. AF, wherein the composition is configured for use in flexographic, screen, offset, inkjet, or other printing, 3D printing, automotive, optical fiber, electronic, adhesive, furniture, flooring, and packaging applications.

Para. AH. An optical fiber coating comprising the polymer of any one of Paras. A-H, Z, and AE.

Para. AI. An ink comprising the polymer of any one of Paras. A-H, Z, and AE.

Para. AJ. The ink of Para. AI, wherein the ink is configured for use in printing, 3D printing, automotive, electronic, optical fiber, furniture, flooring, and packaging applications.

While certain embodiments have been illustrated and described, it should be understood that changes and modifications can be made therein in accordance with ordinary skill in the art without departing from the technology in its broader aspects as defined in the following claims.

The embodiments, illustratively described herein may suitably be practiced in the absence of any element or elements, limitation or limitations, not specifically disclosed herein. Thus, for example, the terms “comprising,” “including,” “containing,” etc. shall be read expansively and without limitation. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the claimed technology. Additionally, the phrase “consisting essentially of” will be understood to include those elements specifically recited and those additional elements that do not materially affect the basic and novel characteristics of the claimed technology. The phrase “consisting of” excludes any element not specified.

The present disclosure is not to be limited in terms of the particular embodiments described in this application. Many modifications and variations can be made without departing from its spirit and scope, as will be apparent to those skilled in the art. Functionally equivalent methods and compositions within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds compositions or biological systems, which can of course vary. It is also to be understood that the terminology used herein is for the purpose of describing particular embodiments only, and is not intended to be limiting.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, particularly in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like, include the number recited and refer to ranges which can be subsequently broken down into subranges as discussed above. Finally, as will be understood by one skilled in the art, a range includes each individual member.

All publications, patent applications, issued patents, and other documents referred to in this specification are herein incorporated by reference as if each individual publication, patent application, issued patent, or other document was specifically and individually indicated to be incorporated by reference in its entirety. Definitions that are contained in text incorporated by reference are excluded to the extent that they contradict definitions in this disclosure.

Other embodiments are set forth in the following claims.

1. A polymer comprising a hyperbranched polyfunctional (meth)acrylate and having a polycarbonate backbone, wherein the polymer is a liquid at 25° C.

2. The polymer of claim 1 which exhibits a viscosity from about 50 centipoise to about 10,000 centipoise at 25° C.

3. (canceled)

4. The polymer of claim 1, wherein the hyperbranched polyfunctional (meth)acrylate further comprising a polycarbonate backbone comprising from about 1 to about 100 acrylate groups per molecule.

5. The polymer of claim 1, wherein the polymer comprises 2 to 50 monomer repeating units per molecule.

6-7. (canceled)

8. The polymer of claim 1, wherein the polycarbonate backbone comprises a polycarbonate polyol, polycarbonate polyester, a polycarbonate polyurethane, or is a co-polymer of any two or more thereof.

9. A process for preparing a polymer comprising a hyperbranched polyfunctional (meth)acrylate having a polycarbonate backbone, the process comprising:
contacting in a solvent a hyperbranched polycarbonate and a (meth)acrylate in the presence of a catalyst to form a reaction mixture; and
heating the reaction mixture under azeotropic reflux conditions to form an alcohol or water from the reaction mixture;
wherein:
the alcohol or water is removed from the reaction mixture under the azeotropic reflux conditions; and
the solvent comprises a C₅-C₁₀ alkane, a C₅-C₁₀ cycloalkane, or an aromatic solvent.

10. The process of claim 9, wherein the heating is conducted from about 70° C. to about 140° C.

11. The process of claim 9, wherein the catalyst comprises a strong acid, strong base, a transesterification catalyst, a Lewis acid, a Bronsted acid, or an amine.

12-15. (canceled)

16. The process of claim 9, wherein an overhead temperature of the reaction has an azeotropic distillation temperature from about 40° C. to about 80° C.

17-19. (canceled)

20. The process of claim 9, wherein the heating is from about 70° C. to about 140° C.

21. (canceled)

22. The process of claim 9, wherein the (meth)acrylate comprises acrylic acid, methacrylic acid, methylmethacrylic acid, methylmethacrylate, ethylmethacrylate, a hydroxy vinyl ether, methyl acrylate, ethyl acrylate, n-propyl acrylate, isopropyl acrylate, n-butyl acrylate (BA), n-decyl acrylate, isobutyl acrylate, n-amyl acrylate, n-hexyl acrylate, isoamyl acrylate, 2-hydroxyethyl acrylate, 2-hydroxypropyl acrylate, N,N-dimethylaminoethyl acrylate, N,N-diethylaminoethyl acrylate, t-butylaminoethyl acrylate, 2-sulfoethyl acrylate, trifluoroethyl acrylate, glycidyl acrylate, benzyl acrylate, allyl acrylate, 2-n-butoxyethyl acrylate, 2-chloroethyl acrylate, sec-butyl-acrylate, tert-butyl acrylate, 2-ethylbutyl acrylate, cinnamyl acrylate, crotyl acrylate, cyclohexyl acrylate, cyclopentyl acrylate, 2-ethoxyethyl acrylate, furfuryl acrylate, hexafluoroisopropyl acrylate, methallyl acrylate, 3-methoxybutyl acrylate, 2-methoxybutyl acrylate, 2-nitro-2-methylpropyl acrylate, n-octylacrylate, 2-ethylhexyl acrylate, 2-phenoxyethyl acrylate, 2-phenylethyl acrylate, phenyl acrylate, propargyl acrylate, tetrahydrofurfuryl acrylate and tetrahydropyranyl acrylate, methyl methacrylate, ethyl methacrylate, n-propyl methacrylate, n-butyl methacrylate (BMA), isopropyl methacrylate, isobutyl methacrylate, n-amyl methacrylate, n-hexyl methacrylate, isoamyl methacrylate, 2-hydroxyethyl methacrylate, 2-hydroxypropyl methacrylate, N,N-dimethylaminoethyl methacrylate, N,N-diethylaminoethyl methacrylate, t-butylaminoethyl methacrylate, 2-sulfoethyl methacrylate, trifluoroethyl methacrylate, glycidyl methacrylate (GMA), benzyl methacrylate, allyl methacrylate, 2-n-butoxyethyl methacrylate, 2-chloroethyl methacrylate, sec-butyl-methacrylate, tert-butyl methacrylate, 2-ethylbutyl methacrylate, cinnamyl methacrylate, crotyl methacrylate, cyclohexyl methacrylate, cyclopentyl methacrylate, 2-ethoxyethyl methacrylate, furfuryl methacrylate, hexafluoroisopropyl methacrylate, methallyl methacrylate, 3-methoxybutyl methacrylate, 2-methoxybutyl methacrylate, 2-nitro-2-methylpropyl methacrylate, n-octylmethacrylate, 2-ethylhexyl methacrylate, 2-phenoxyethyl methacrylate, 2-phenylethyl methacrylate, phenyl methacrylate, propargyl methacrylate, tetrahydrofurfuryl methacrylate, tetrahydropyranyl methacrylate, hydroxyalkyl acrylates and methacrylates, acrylic acid and its salts, acrylonitrile, acrylamide, methyl α-chloroacrylate, methyl 2-cyanoacrylate, N-ethylacrylamide, N,N-diethylacrylamide, acrolein, methacrylic acid and its salts, methacrylonitrile, methacrylamide, N-methylmethacrylamide, N-ethylmethacrylamide, N,N-diethylmethacrylamide, N,N-dimethylmethacrylamide, N-phenylmethacrylamide, or methacrolein.

23. The process of claim 9, wherein the (meth)acrylate comprises an alkanol (meth)acrylate ester.

24. The process of claim 9, wherein the (meth)acrylate comprises methyl (meth)acrylate.

25. The process of claim 8, wherein the polycarbonate polyol backbone comprises a polycarbonate polyol that has a viscosity of about 500 centipoise to greater than 100,000 centipoise at 25° C.

26. (canceled)

27. A process for preparing a polymer comprising a hyperbranched polyfunctional (meth)acrylate having a polycarbonate backbone, the process comprising:
contacting a hyperbranched polycarbonate polyol and a catalyst in a solvent to form a first reaction mixture;
cooling the first reaction mixture to about 0° C.;
adding an acryloyl halide or (meth)acrylic acid to the first reaction mixture to form a second reaction mixture, wherein a temperature of the reaction mixture does not exceed about 5° C. during addition; and
after a predetermined amount of time, warming the second reaction mixture to about 25° C.

28. The process of claim 27, wherein the hyperbranched polycarbonate polyol comprises secondary alcohol groups.

29-30. (canceled)

31. A polymer comprising the hyperbranched polyfunctional (meth)acrylate having, a polycarbonate backbone, prepared by the process of claim 27.

32-33. (canceled)

34. An optical fiber coating comprising the polymer of claim 1,.

35. An ink comprising the polymer of claim 1.

36. The ink of claim 35, wherein the ink is configured for use in printing, 3D printing, automotive, electronic, optical fiber, furniture, flooring, and packaging applications.
